(19) United States
(12) Patent Application Publication
(10) Pub. No.: US 2011/0303520 A1
(43) Pub. Date: Dec. 15, 2011

(54) DOUBLE ACTION ELECTRICAL SWITCH WITH A TACTILE EFFECT

(75) Inventors: Thierry Burnel, Dole (FR); Laurent Kubat, Dole (FR)

(73) Assignee: COACTIVE TECHNOLOGIES LLC, Newton, MA (US)

(21) Appl. No.: 13/155,982

(22) Filed: Jun. 8, 2011

(30) Foreign Application Priority Data
Jun. 11, 2010 (FR) 1054617

(51) Int. Cl. H01H 3/02

(52) U.S. Cl. 200/512

(57) ABSTRACT

A switch comprising a first peripheral contact; a second peripheral contact; a third central fixed contact; a movable contact element which can be displaced and deformed elastically from a stable rest state comprising a peripheral zone capable of bearing simultaneously against the two first contacts in order to establish a first switching path, and a central section on which an actuating element acts, and which is capable of then bearing against the third contact to establish a second switching path, characterized in that the movable contact element occupies an initial raised rest position in which the peripheral zone does bears against either of the two first contacts, and in that the movable contact element occupies a final lowered switching position in which the peripheral zone bears simultaneously against the two first contacts to establish the first switching path.

### CROSS REFERENCE TO RELATED APPLICATION

This application claims priority to France Patent Application No. 1054617 filed Jun. 11, 2010, the content of which is hereby incorporated by reference in its entirety.

Not Applicable

### BACKGROUND

The present disclosure relates to an electrical switch of the type configured to provide at least two electrical switching paths to be established successively by means of an actuator or actuating means on which the user pushes by exerting a pressure.

Different designs have been proposed for such a so-called “dual-action” or “dual-pressure” switch.

U.S. Pat. No. 4,659,881, the content of which is hereby incorporated by reference in its entirety, discloses a switch comprising two electrically conductive coaxial superposed domes which function as movable contacts and successively control a priming function and then a triggering function.

A second solution is described in U.S. Pat. No. 5,898,147, the content of which is hereby incorporated by reference in its entirety, which makes use of two trigger elements which function as movable contacts, each comprising four radial arms which are superposed and interlocking.

A third document, U.S. Pat. No. 4,359,614, the content of which is hereby incorporated by reference in its entirety, also discloses a switch comprising a lower dome forming a movable contact surmounted by an elastically deformable contact crossbar.

Amongst the same family of documents, all comprising at least one “fixed” lower dome which bears via its annular lower edge against a support carrying fixed contacts, U.S. Pat. No. 5,564,560, the content of which is hereby incorporated by reference in its entirety, in order to establish the first switching path, makes use of a flexible circuit with conductive areas which bear against the upper face of the dome in conjunction with an actuating axial pusher comprising a movable contact chip which, on completion of a first actuating travel, establishes a first switching path between these conductive areas.

U.S. Pat. No. 6,498,312, the content of which is hereby incorporated by reference in its entirety, discloses a one-piece “double” triggering element with two sets of radial arms, in which solution this triggering and movable contact element is deformed twice successively in order to establish the two switching tracks.

All these solutions take up a particularly large amount of space, in particular along the axis of actuation, as they make use of two superposed domes or a plurality of superposed contact components, or alternatively require electrical contacts outside the area delimited by the dome. Precise adjustment of the switch and in particular control of the actuating forces is particularly complicated when use is made of two domes or a similar implementation.

U.S. Pat. No. 4,385,218, the content of which is hereby incorporated by reference in its entirety, discloses a switch which comprises a single dome forming a triggering element and a movable contact element which is deformed in two successive stages in order to establish successively a first electrical switching path between peripheral fixed contacts, and then is deformed a second time in order to establish a second electrical switching path between these peripheral contacts and a fixed central contact.

In this embodiment, in which the single triggering element or dome bears initially against the base of the housing which receives it, the problems inherent in the large size are at least partially resolved but the industrial production of such a specially shaped dome including, in particular, a cut-out which divides it into at least two concentric parts and enables it to be deformed twice, as well as the serviceable life of such a dome which is subjected to large deformations, are complex and entail an insufficient serviceable life. Moreover, here too it is very difficult to control the forces which are felt successively by the user.

### SUMMARY

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this document is to be construed as an admission that the embodiments described in this document are not entitled to antedate such disclosure by virtue of prior invention. As used in this document, the term “comprising” means “including, but not limited to.”

In order to overcome the disadvantages which have just been mentioned, the present disclosure proposes a dual-action tactile-effect electrical switch comprising: an insulating support comprising an upper face extending in a horizontal plane having at least three fixed electrical contacts including a first peripheral contact, a second peripheral contact, and a third central fixed contact; a movable contact element configured to be displaced and deformed elastically from a stable rest state in response to an action of an actuating element which acts in an overall vertical direction; and an upper triggering dome configured to change state, wherein the upper triggering dome is interposed vertically between the actuating element and the movable contact element and is configured to provides a tactile sensation by a sudden change of state when the second switching path is established, wherein the upper triggering dome is electrically isolated from the at least three fixed electrical contacts. The movable contact comprises a peripheral zone configured to bear simultaneously against the first peripheral contact and the second peripheral contact in order to establish a first switching path, and an upper central section on which the actuating element acts, the upper central section configured to bear against the third central fixed electrical contact to establish an electrical connection between the first and second peripheral contacts and the third central fixed contact to establish a second switching path, following the establishment of the first path. In the stable rest state, the movable contact occupies an initial raised rest position to which the movable contact is returned elastically, wherein the peripheral zone does not contact either of the first or second peripheral contacts in the stable rest state. After the movable contact has been subjected to a first elastic deformation from action of the actuating element, the movable contact occupies a final lowered switching position in which the peripheral zone bears simultaneously against the first and second peripheral contacts to establish the first switching path.

According to other features of the disclosure:
in its initial raised position, the movable contact element extends in a plane which forms an acute angle with the horizontal plane and, in its final lowered position, the movable contact element extends in a plane parallel to the horizontal plane;
the movable contact element has the general shape of a plate, or a spherical cap, delimited by a lower plane; in its initial stable rest state, the movable contact element comprises a part which is folded in such a way that the free lower end of this part is offset vertically downwards relative to the lower plane; in the initial raised rest position of the movable contact, the lower free end of the folded part bears against the insulating support; and in the final lowered position of the movable contact element, the lower plane extends in a horizontal plane and the lower plane bears against the two first fixed peripheral contacts;
the lower end of the folded part bears against the insulating support at a point situated between the two first fixed peripheral contacts;
the switch comprises means for orienting the movable contact element at an angle relative to the fixed contacts;
the lower end of the folded part bears against the insulating support at a point formed in a recess so as to position the movable contact element at an angle relative to the fixed contacts;
the movable contact element has the general shape of a cut-out plate comprising two contact flanges each arranged opposite a fixed contact, and in that the folded part is a bearing tab which extends between the two flanges;
the movable contact element has the shape of a spherical cap with a continuous structure folded about a chord;
the switch comprises a support carrying contacts which delimits a housing with a base delimited by the upper horizontal surface; and
the rigidity of the upper triggering dome is considerably greater than that of the movable contact element.

### BRIEF DESCRIPTION OF THE DRAWINGS

Other features and advantages of the invention will become apparent on reading the following detailed description, given with no limitation being implied, of two embodiments of the invention, for the understanding of which reference will be made to the attached drawings in which:

FIG. 1 illustrates a perspective three-quarter view from above of a first embodiment of an electrical switch according to the invention in which the switch is shown without its upper sealing film;

FIG. 2 illustrates a view similar to that in FIG. 1 in which the switch is shown without its actuating pusher, without its upper triggering dome and without its movable contact element;

FIG. 3 illustrates an exploded perspective view in the vertical actuating direction which shows the components of the electrical switch from FIG. 1, as well as the sealing film;

FIG. 4 illustrates a view from above of the switch as illustrated in FIG. 2;

FIG. 5 illustrates a view on a large scale in section through a median longitudinal vertical plane of the switch from FIG. 1, which illustrates the seat and the folded movable contact element;

FIG. 6 illustrates a view similar to that in FIG. 5 in which the folded movable contact element is illustrated in an exploded view above the seat;

FIG. 7 illustrates a detailed view illustrating in perspective the metal contact strips of the switch illustrated in particular in FIG. 2, before the insulating casing has been over-molded;

FIG. 8 illustrates a view similar to that in FIG. 3 which illustrates a second embodiment of the movable contact element;

FIG. 9 illustrates a view similar to that in FIG. 2 in which the lower casing houses the movable contact element according to a second embodiment;

FIGS. 10 and 11 illustrate views similar to those in FIGS. 5 and 6 with the movable contact element according to a second embodiment.

In the following description, in order to make it easier to understand and to make the claims clear, the terms vertical, horizontal, longitudinal, transverse, etc will be used with reference to the L, V, T reference system illustrated in the Figures, with no limitation being implied and with reference to the Earth's gravity. In the description which follows, identical, similar or analogous components will be designated by the same reference numerals.

### DETAILED DESCRIPTION

A control system as disclosed herein allows a user to exert successively an initial slight pressure in order to establish a first switching path, and then a greater pressure in order to establish a second electrical switching path.

In the first phase, the user perceives a certain elastic resistance and then, when the second switching path is established, the switch gives the user a tactile sensation that this switching path has been established.

The tactile sensation is obtained by means of an elastically deformable triggering element, for example in the form of a dome, on which the pressure exerted causes a sudden change of state which makes it possible, on the one hand, to establish an electrical switching path and, on the other hand, to provide the tactile sensation.

Such a type of dual-action or dual-pressure switch is used in a large number of electronic appliances and especially in cameras or video cameras in which the button which controls the shutter release is actuated in two stages by axial travel, for example in order to effect, in a first stage, the automatic focusing or “auto-focus” and then, in a second stage, the actual release of the shutter and/or the recording of the digital file.

Other applications in which two electrical switching paths need to be established successively, for example in order to establish two consecutive signals, include buttons for controlling selection and then confirmation, or buttons for controlling the priming of a function and then controlling the implementation of this function.

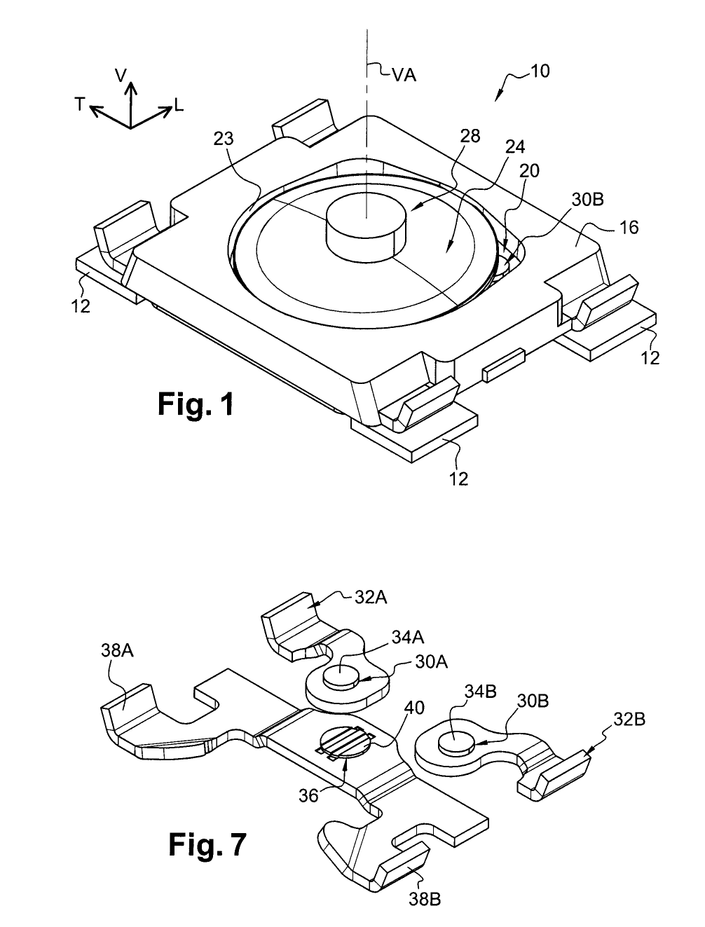

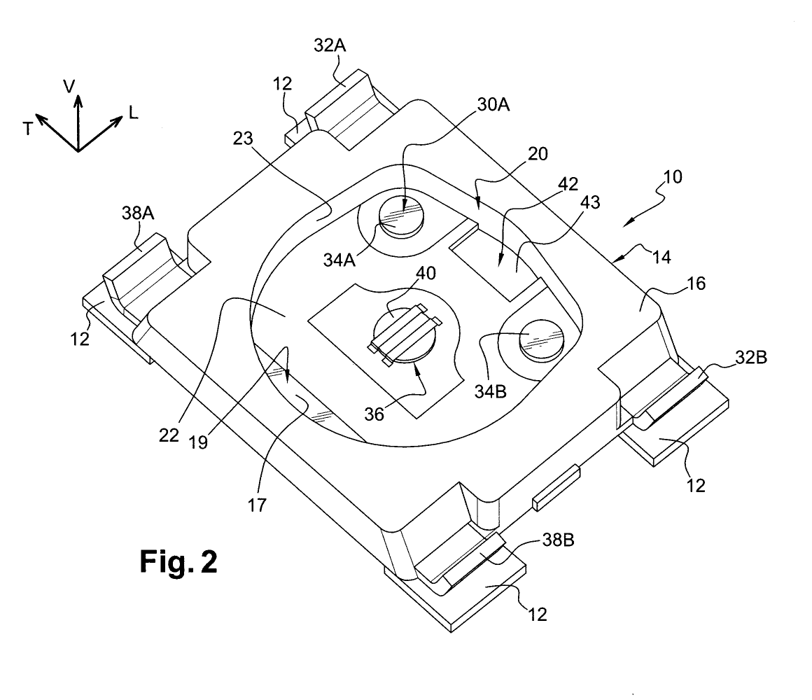

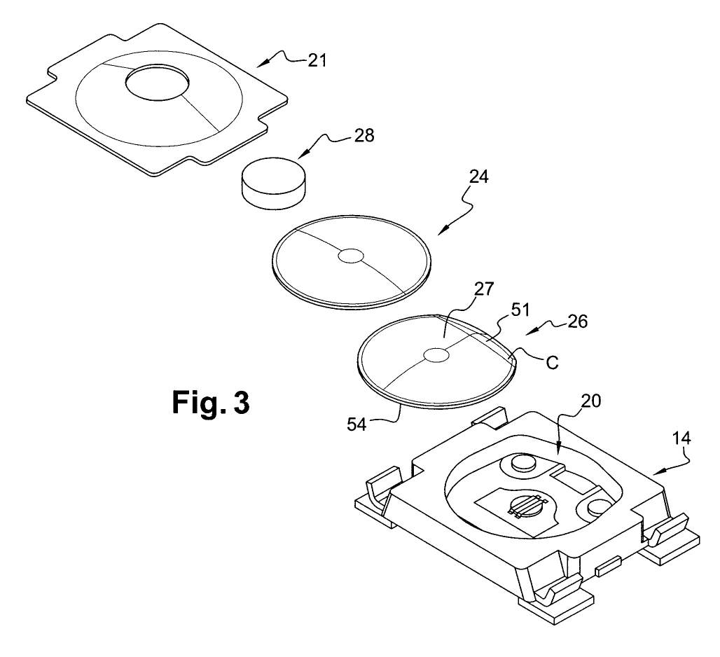

FIGS. 1 to 4 show a dual-action electrical switch 10 which is here, with no limitation being implied, shown in the form of a separate unit which is intended in particular to be fixed by welding to a PCB 12 (Printed Circuit Board), four parts of which are illustrated in the figures.

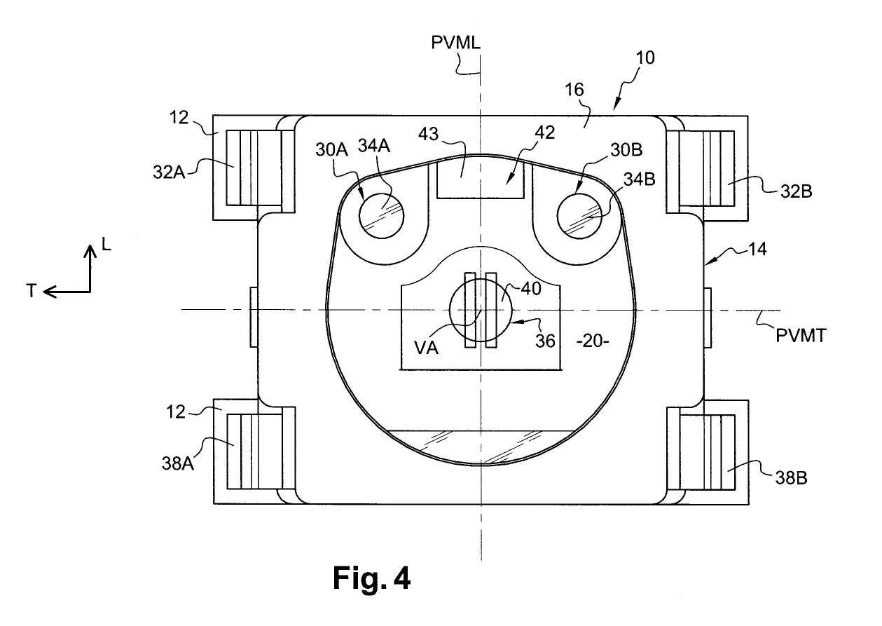

The electrical switch 10 is generally symmetrical in design with respect to the median vertical and longitudinal plane PVML indicated in FIG. 4.

As is widely known in the switching field, the switch 10 may include a seat, or casing 14, which has the general shape of a rectangular parallelepiped and is produced by being molded from electrically insulating plastic material. The casing 14 is in particular delimited by its upper horizontal face 16 and by its lower horizontal face 18. In its central part, the casing 14 may include a housing 20 which is open vertically upwards in the upper face 16 and which is delimited by a plane horizontal base 22, and by a concave cylindrical vertical side wall 23.

In the assembled position of the components, the housing 20 may house, at least partially, the folded movable contact element 26, whilst the actuating element, or pusher 28, extends vertically above the plane of the upper face 16. The housing 20 may also house an upper dome 24 with a known general shape in the form of a spherical cap, which is an upper dome with a sudden change of state which is interposed vertically between the actuator and the movable contact element 26, and which provides a tactile sensation as a result of a sudden change of state when the second switching path is established but does not participate, from the point of view of electrical conductivity, in the establishment of the electrical switching paths as the upper dome is electrically insulated from the fixed contacts. In this respect, the dome 24 is not necessarily made from metal.

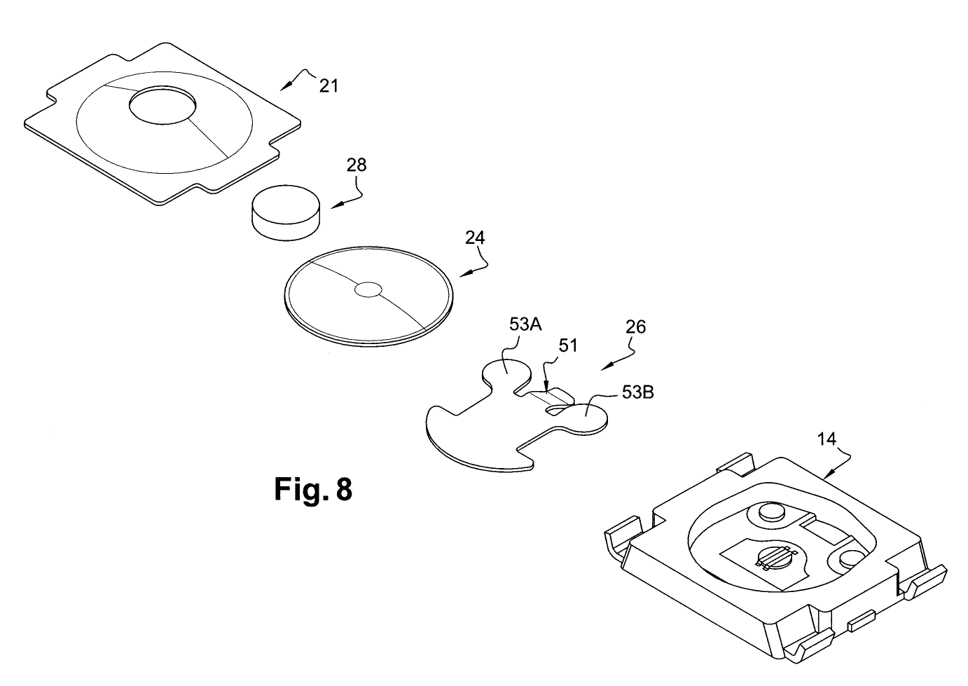

In the assembled position of the components, the switch 10 may be covered by a closing sealing film 21, which ensures a sealing closure of the top of the housing 20, and to which the pusher 28 is fixed by adhesive bonding. According to a known technique, the casing 14 may be over-molded around various cut-out and folded metal strips, as is illustrated in detail in FIG. 7, in order to form the fixed contacts and the associated connecting terminals.

The switch 10 may include, in the base of the housing 20, a first and a second fixed peripheral contact 30A and 30B, each of which is independently connected electrically to the outside by an associated connecting terminal 32A, 32B which is designed so as to be able to be connected electrically to a corresponding track formed opposite the upper part of the printed circuit board 12. Each fixed peripheral contact 30A, 30B may be arranged close to the vertical side wall 23 of the housing 20 and it may take the form of a circular chip which is here formed so that it projects vertically in such a way that its free upper horizontal face 34A, 34B extends above the plane of the upper horizontal face formed by the base 22 of the housing 20.

In the same way, the switch may include a third fixed central contact 36 which is a shared fixed contact connected electrically to two other electrical connecting terminals 38A and 38B, which are in turn configured to be connected to corresponding conductive tracks on the printed circuit board 12. The fixed central contact 36 may also be produced in the form of a circular chip, the upper face 40 of which extends in a horizontal plane at a height, relative to the plane base 22, which is slightly lower than that of the upper faces 34A and 34B.

A cavity 42 may be provided, in the base of the housing 20, for positioning the folded movable contact element 26 at an angle, extending vertically downwards in a hollow and is integrally molded from insulating plastic material. The cavity 42 may be centered, relative to the plane PVML, between the two fixed contacts 30A and 30B.

Longitudinally opposing the cavity 42, the base of the housing 20 may include a bearing step 19 for the movable contact element 26, which projects vertically upwards and which is integrally molded from insulating plastic material. The bearing step 19 may be centered relative to the plane PVML and its upper plane horizontal face 17 may be in the same plane as the upper faces 34A and 34B of the fixed peripheral contacts 30A and 30B. The housing 20 may receive and position the movable contact element 26 in an initial raised rest position.

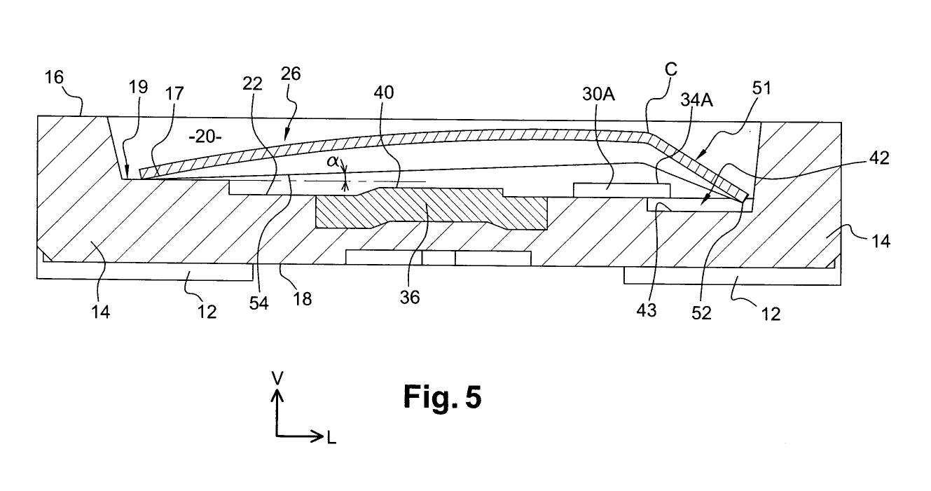

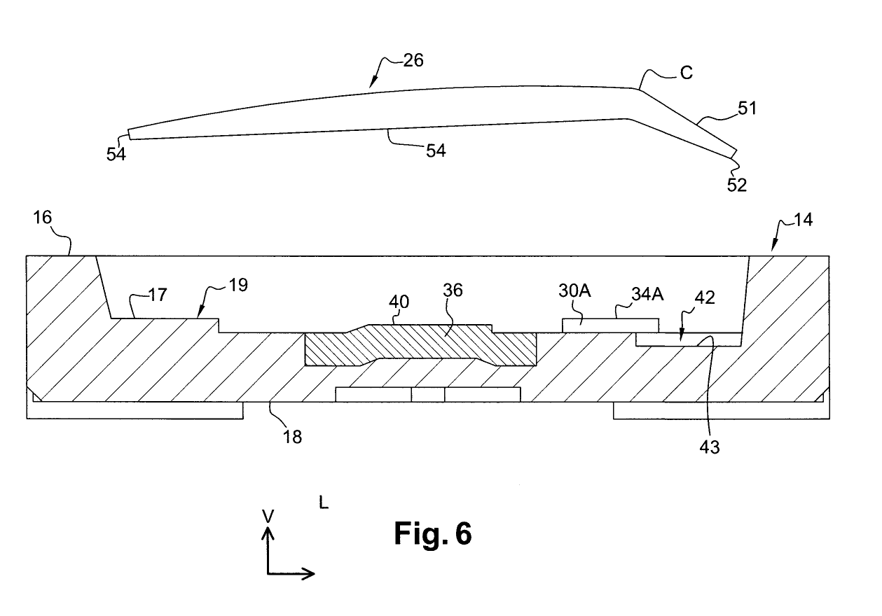

As shown in particular in FIGS. 5 and 6, the movable contact element 26 overall may have the form of a dome folded about a chord. More precisely, before it is folded or curved, the movable contact element 26 here, like the upper dome 24, may take the form of a spherical cap with a continuous structure which is, for example, made from metal by being curved and which is delimited at its lower part by a peripheral lower circular edge 54.

In its conventional, unfolded design, and as used in a conventional electrical switch with a single switching path, all the points of the lower peripheral edge 54 may be in the same plane and may belong to a common lower plane, e.g., they extend in a common plane which may bear against a horizontal plane base over virtually its entire periphery, this bearing zone generally including at least one fixed peripheral electrical contact.

The movable contact element 26 may also include an upper domed central section which is delimited by a convex upper face 27. It is on this upper surface 27 of the central domed section which the actuating element or pusher 28 may act, indirectly, via the upper triggering dome 24. The movable contact element 26 may be, in its stable rest state, folded about a chord or fold C in such a way that all those points belonging to a section of the outer peripheral edge 54, which are situated radially opposite the central axis relative to the chord C, are offset vertically downwards relative to the general plane in which the edge 54 extends. The movable contact element 26 thus may include a folded part 51, the lower free end of which, here virtually a point, is offset vertically downwards relative to the plane of the lower edge.

As can be seen in FIG. 5 or 6, the movable contact element 26 thus includes an end point 52 of the downwardly folded part, which is the lowest vertically situated point relative to the plane of the lower edge 54. In the stable rest position of the movable contact element 26, when positioned in the housing 20, the point 52 is received in the base of the cavity 42, bearing against the base 43 of this cavity 42. Thus, in addition to its bearing function, the point 52 cooperating with the cavity 42 may effect an angular positioning of the movable contact element 26 about the central axis VA.

In this initial stable rest position, the point of the lower edge 54, which is diametrically opposite the point 52, bears against the upper face 17 of the step 19. The movable contact element 26 is thus positioned angularly in the housing 20, with play, in particular so that it may not rotate in the housing, and that its movements are limited to the deforming and tilting movements, which will be described below, when it is deformed elastically. The dimensions, and in particular the external diameter, of the movable contact element 26 are such that it is housed at least partially and positioned in the housing 20.

As can be seen in FIG. 5, the points of the lower edge 54 of the movable contact element 26, including those of its folded end part, are not in contact with, and do not bear against, and therefore are neither in electrical contact with, the upper faces 34A and 34B of the fixed peripheral contacts 30A and 30B. The movable contact element 26, with a known general design, in particular for creating a tactile effect when it is deformed elastically with a sudden change of state, may be electrically conductive at least on its lower and inner concave face.

As shown in FIG. 5, in the rest position of the switch 10, in other words when the user does not exert any force on the actuating pusher 28, the lower edge 54 of the movable contact element 26 may be inclined at an angle alpha, relative to the horizontal plane of the faces 17, 34A and 34B, and that part of its lower edge which extends opposite the upper faces 34A and 34B of the two fixed peripheral contacts 30A and 30B is situated vertically above these faces, in other words there is no electrical contact between the movable contact element 26 and the fixed peripheral contacts 30A and 30B.

When, via the pusher 28, the user exerts a force on the upper convex face 27 of the movable contact element 26 in the vertical direction of the arrow F in FIG. 5 (this force being substantially centered on the vertical axis VA), the first pressing force exerted on the movable contact element 26, via the upper triggering dome 24, may cause a first elastic deformation of the movable contact element 26 which is deformed, overall about the chord or fold C and counter to its inherent elasticity, in order to “resume” a “conventional” form similar to that of the upper triggering dome 24 in which all the points of the lower edge all extend substantially in the same lower plane, the continuous lower edge moreover being horizontal as a result of a simultaneous tilting effect of the movable contact element 26.

On completion of this first deformation, the movable contact element 26 may then occupy a lowered position in which the corresponding points of its lower electrically conductive edge simultaneously bear with electrical contact against the coplanar upper faces 34A, 34B of the fixed peripheral contacts 30A and 30B. The movable contact element 26 is thus displaced from its initial raised rest position as illustrated in FIG. 5 toward its final lowered switching position in which its annular peripheral edge 54 bears against the two first fixed peripheral contacts 30A, 30B in order to establish the first electrical switching path between these contacts, and hence between the terminals 32A and 32B.

On completion of the first actuating phase, the movable contact element 26 may be substantially “flat” and is situated in a “conventional” position in which it bears in a horizontal plane via its lower peripheral annular zone, or lower edge, in order to then allow its “conventional” sudden change of state. Then, by continuing to apply a pushing force in the direction of the arrow F with a greater value, the user may cause, in a known fashion, the simultaneous elastic deformation of the upper triggering dome 24 and of the movable contact element 26 and their sudden change of state. On completion of this second deformation, the lower conductive face of the central part of the movable contact element 26 comes into electrical contact with the upper face 40 of the fixed central contact 36.

In addition to the tactile sensation that it creates for the user, this deformation may then establish the second electrical switching path between the fixed central contact 36 and the fixed peripheral contacts 30A and 30B, in other words between the connecting terminals 38A, 38B and 32A, 32B.

By way of example, the first actuating travel is equal to approximately 0.1 mm with a force of 1 Newton, whilst the second actuating travel is equal to approximately 0.2 mm with an actuating force equal to 2.5 Newtons, for a triggering element 24 with a diameter equal to 2 mm.

By way of additional example, for such a dome with a diameter equal to 2 mm, the chord or fold C is situated at a distance of approximately 0.7 mm from the centre of the folded movable contact element 26.

The extra upper triggering dome 24, with a conventional unfolded design, makes it possible, in a known fashion, to increase the value of the different elastic restoring forces and the tactile sensation but it does not participate in the establishment of the electrical switching path to the extent that its upper position, bearing against the upper face of the folded movable contact element 26, prevents any participation or cooperation with the fixed contacts.

By way of example, the different fixed contacts could belong directly to a rigid or flexible printed circuit board.

The invention is also not limited to two fixed peripheral contacts. Indeed, it is, for example, possible to provide a third fixed contact (not shown) which is electrically independent from the two fixed peripheral contacts 30A and 30B, which is arranged in the base 43 of the cavity 42 and which is connected to the outside by an associated connecting terminal which is designed such that it can be connected electrically to a corresponding track formed opposite the upper part of the printed circuit board 12.

The movable contact element 26 is thus permanently in electrical contact with this third fixed electrical contact—which does not belong to the two first switching paths—and, on completion of the second deformation phase, the movable contact element 26 may simultaneously establish two electrical switching paths, the second path mentioned above and a third between this extra fixed contact and the fixed central contact 36. The angular positioning of the movable contact element can alternatively be effected not by the lowest point 52 but, for example, by an angular positioning tab which can be integrally formed by cutting and folding and which is received in a cavity or a notch provided for this purpose.

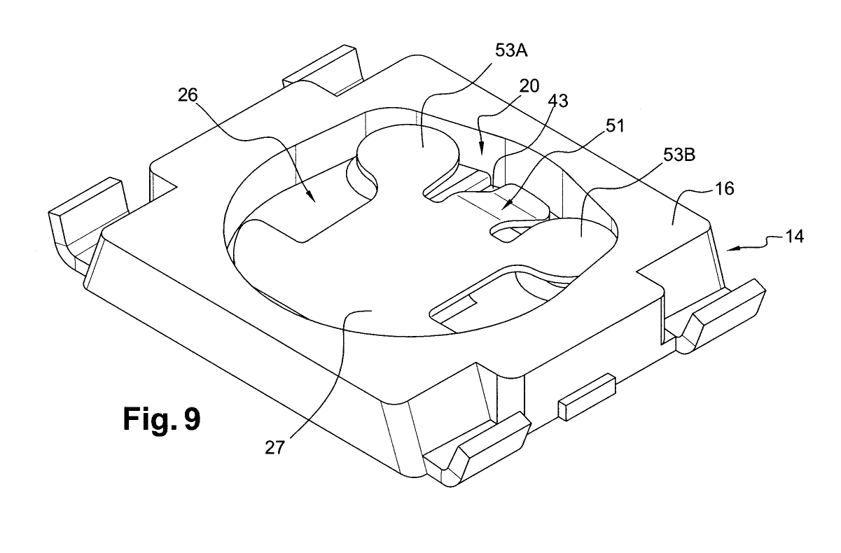

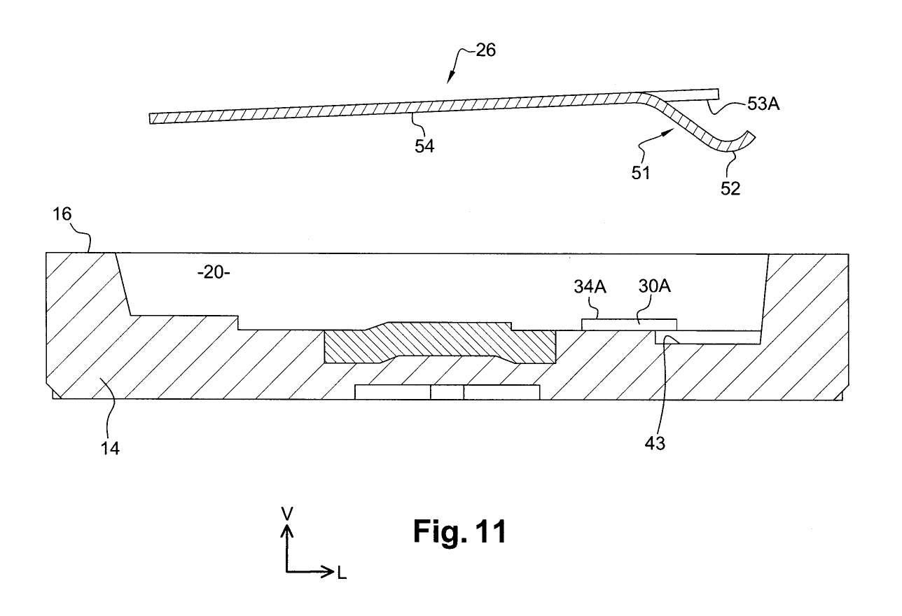

A second embodiment as illustrated in FIGS. 8 to 11 differs from the first in the design of the movable contact element 26. The movable contact element 26 here is in the form of a metal plate that has been cut out and bent, and has a continuous structure with an electrically conductive plane lower face 54. The general contour of the plate which forms the movable contact element 26 may complement overall the concave internal profile of the housing 20.

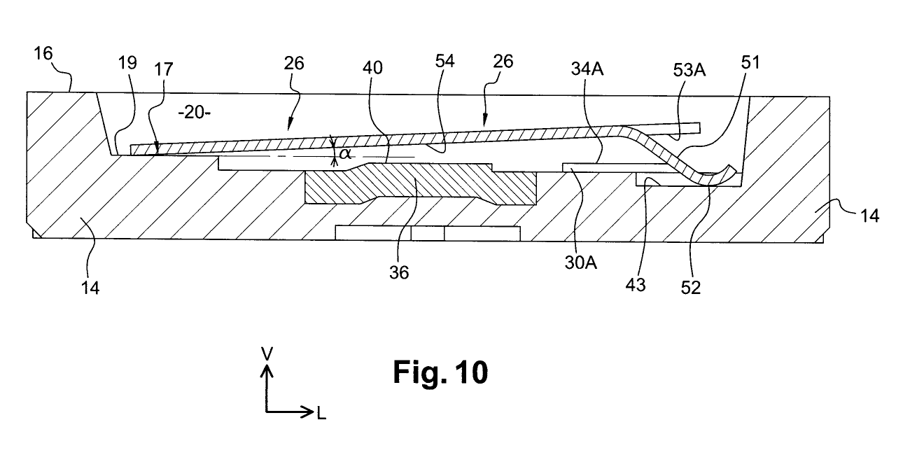

In its rear part and on the left-hand side, looking at FIGS. 9 to 11, the plate which forms the movable contact element 26 may include a peripheral edge in the form of a circular section, like the movable contact element 26 in the first embodiment. In the initial stable rest position, the point of this lower edge may bear against the upper face 17 of the step 19. Diametrically opposite this rear left-hand point, the plate which forms the movable contact element 26 may include a tab 51 which is cut out and folded vertically downwards and thus extends below the general plane of the plate.

At its free end, the folded tab 51 may be shaped with a convexity which is oriented vertically downwards and it thus delimits a transverse line 52 for bearing against the face 43 of the base of the housing 42 in which the free end of the folded tab 51 is received. The folded tab 51 for bearing and angular positioning of the plate which forms the movable contact element 26 may extend between two flanges 53A and 53B, each of which is a movable contact flange which is capable of coming into electrical contact with the upper face 34A, 34B of the opposite fixed peripheral contact 30A, 30B, on completion of the phase of the deformation of the tab 51 and displacement, by tilting, of the movable contact plate 26.

The central zone 27 of the plate, which is analogous to the central zone of the upper convex face 27 of the movable contact element 26 in the first embodiment, may be a solid portion, the lower electrically conductive face of which extends opposite the upper face 40 of the fixed central contact 36.

The upper triggering dome 24, which may be delimited by a circular or annular peripheral edge, may permanently bear against corresponding zones of each of the two flanges 53A and 53B, and of the plate which forms the movable contact element 26.

The actuating element 28 may act indirectly on the plate which forms the movable contact element 26, via the upper triggering dome 24 which has a considerably greater rigidity than the plate which forms the movable contact 26 with its deformable tab 51.

In the first actuating phase, the actuating element 28 and the dome 24 may cause the deformation of the tab 51 and hence the tilting, by the angle alpha, of the plate which forms the movable contact element 26 with a view to establishing the first switching path.

In this final lowered position of the plate 26, the latter may be held in a plane horizontal bearing position by the annular peripheral edge of the upper triggering element 24.

The additional action at the centre of the triggering element 24 may cause its sudden change of state, such that its central portion then strikes the opposite central zone 27 of the plate, which forms the movable contact element 26, which is deformed so that, after a very short travel, it comes to bear with electrical contact against the upper face 40 of the fixed central contact 36, and thus establishes the second electrical switching path. Because the plate which forms the movable contact element 26, as in the first embodiment, has no cut-out or central recess, it may have a high degree of rigidity which is especially important for making it possible to produce a switch with very small dimensions, in particular when the general diameter of the movable contact element 26 and of the triggering dome 24 is less than or equal to 2 millimeters.

The design according to the present disclosure which has just been described takes up a particularly small amount of space, both vertically and laterally, and it moreover makes it possible to produce, with a same “lower part”, in other words with a same casing or seat 14, a single-action electrical switch by placing in the housing 20 a conventional triggering dome analogous to the triggering dome 24 which is then initially at rest in electrical contact via its lower edge with the two fixed peripheral contacts 30A and 30B, or alternatively an electrical switch according to the invention with two electrical switching paths established successively by using a movable contact element 26 in the form of a folded dome.

The invention is not limited to a switch actuated by a vertical pusher but can also be applied in the case of lateral actuation with transfer of the movement along the vertical axis.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

What is claimed is:

1. A dual-action tactile-effect electrical switch comprising:
an insulating support comprising an upper face extending in a horizontal plane having at least three fixed electrical contacts including a first peripheral contact, a second peripheral contact, and a third central fixed contact;
a movable contact element configured to be displaced and deformed elastically from a stable rest state in response to an action of an actuating element which acts in an overall vertical direction, the movable contact comprising:
a peripheral zone configured to bear simultaneously against the first peripheral contact and the second peripheral contact in order to establish a first switching path, and
an upper central section on which the actuating element acts, the upper central section configured to bear against the third central fixed electrical contact to establish an electrical connection between the first peripheral contact and the second peripheral contact, and the third central fixed contact to establish a second switching path, following the establishment of the first path,
wherein, in the stable rest state, the movable contact occupies an initial raised rest position to which the movable contact is returned elastically, wherein the peripheral zone does not contact either of the first or second peripheral contacts in the stable rest state, and, after the movable contact has been subjected to a first elastic deformation from action of the actuating element, occupies a final lowered switching position in which the peripheral zone bears simultaneously against the first peripheral contact and the second peripheral contact to establish the first switching path; and
an upper triggering dome configured to change state, wherein the upper triggering dome is interposed vertically between the actuating element and the movable contact element and is configured to provides a tactile sensation by a sudden change of state when the second switching path is established, wherein the upper triggering dome is electrically isolated from the at least three fixed electrical contacts.

2. The switch of claim 1, wherein the movable contact, in its initial raised position, extends in a second plane which forms an acute angle with the horizontal plane, and, when the movable contact is in its final lowered position, extends in a plane parallel to the said horizontal plane.

3. The switch of claim 2, wherein:
the movable contact element is generally shaped as a plate or a spherical cap, delimited by a lower plane such that:
in the stable rest state, the movable contact element comprises at least a part which is folded in such that a free lower end of the folded part is offset vertically downwards relative to the lower plane,
in the initial raised rest position, the lower free end of the folded part bears against the insulating support, and
in the final lowered position, the lower plane extends in a horizontal plane and the said lower plane bears against the first peripheral contact and the second peripheral contact.

4. The switch of claim 3, wherein the lower end of the folded part bears against the insulating support at a point situated between the first peripheral contact and the second peripheral contact.

5. The switch of claim 4, further comprising means for orienting the movable contact element at an angle relative to the first peripheral contact and the second peripheral contact.

6. The switch of claim 5, wherein the lower end of the folded part bears against the insulating support at a point formed in a recess so as to position the movable contact element at an angle relative to the first peripheral contact and the second peripheral contact.

7. The switch of claim 4, wherein the movable contact element is generally shaped as a cut-out plate comprising two contact flanges arranged opposite the first peripheral contact and the second peripheral contact, wherein the folded part is a bearing tab which extends between the two contact flanges.

8. The switch of claim 3, wherein the movable contact element is shaped as a spherical cap with a continuous structure folded about a chord.

9. The switch of claim 1, further comprising a support configured to carry the at least three fixed electrical contacts and delimit a housing having a base delimited by the upper horizontal surface.

10. The switch of claim 1, wherein a rigidity of the upper triggering dome is greater than that of the movable contact element.
